(19) United States
(12) Patent Application Publication
(10) Pub. No.: US 2004/0243394 A1
(43) Pub. Date: Dec. 2, 2004

(54) Natural language processing apparatus, natural language processing method, and natural language processing program

(75) Inventor: Mihoko Kitamura, Tokyo (JP)

Correspondence Address: VENABLE, BAETJER, HOWARD AND CIVILETTI, LLP, P.O. BOX 34385, WASHINGTON, DC, 20043-9998, US

(73) Assignee: Oki Electric Industry Co., Ltd., Tokyo (JP)

(21) Appl. No.: 10/776,518

(22) Filed: Feb. 12, 2004

(30) Foreign Application Priority Data
May 28, 2003 (JP) 2003-150598

(51) Int. Cl. G06F 17/27

(52) U.S. Cl. 704/9

(57) ABSTRACT

There are provided a natural language processing apparatus, a natural language processing method, and a natural language processing program which can improve the accuracy of a parsing result in syntax parsing using a pattern rule. In the natural language processing apparatus, the natural language processing method, and the natural language processing program, a pattern rule with sentence ID to which a sentence ID representing the possibility of simultaneously applying the sentence ID to the same sentence is prepared in advance. When syntax parsing of an input sentence is performed with reference to the prepared pattern rule, a large number of pattern rules to which the same sentence ID is given are included in the parsing result.

### BACKGROUND OF THE INVENTION

The present invention relates to a natural language processing apparatus, a natural language processing method, and a natural language processing program which can be applied to a syntax analyzing process and a translation process using a past analysis result or a past translation result.

### DESCRIPTION OF THE RELATED ART

A syntax analyzing technique of a natural language used in mechanical translation or the like strikingly progresses. In conventional syntax analysis, a dictionary including syntactical information and grammatical rules are formed by human being in advance, and the dictionary and the grammatical rules are used in a parser such as a chart method or Earley method to obtain an analysis result. However, in recent years, study of a syntax analyzing system using the following mechanical learning method has progressed (for example, “Deterministic Bottom-up Parsing with Support Vector Machine in collaboration with Yamada Hiroyasu and Matsumoto Yuji, Research paper “Natural Language Processing”, No. 149-009, May 23, 2002, to be referred to as “Non-Patent Document 1” hereinafter). That is, when there are syntax analysis results of a large number of documents, rules for reproducing the syntax analysis result (learning data) are automatically formed, and then syntax parsing result is obtained on the basis of the rules.

The following method is also proposed (Japanese Patent Laid-open Publication No. 7-295991, to be referred to as “Patent Document 1” hereinafter). That is, syntax parsing results of a large number of documents are stored, a syntax parsing result of an input sentence is compared with the stored syntax parsing results, and a new parsing result is obtained on the basis of the comparison result.

The technique using past cases does not requires a dictionary and grammar which are manually formed. As the number of prepared correct solution results of syntax parsing is increased, parsing accuracy is advantageously improved.

In the technique using past cases is advantageously easily applied to a natural language technique of retrieval, translation, or the like. The method described in Patent Document 1 is applied to mechanical translation such that translated documents are used as cases. In this case, the following method is employed. That is, syntax parsing results of a large number of translated documents are stored, syntax parsing results in the same language of an input sentence are compared with a syntax parsing result of the input sentence, and the most similar syntax parsing result is selected, so that an appropriate translation result is obtained with reference to syntax parsing results in an opposite language of the selected syntax parsing result.

However, since the method in Non-patent Document 1 uses mechanical learning, learning data (rule) which is formed in advance cannot be understood by human being, and cannot be changed. More specifically, the rule cannot be manually regulated to obtain a good analysis result. In addition, since the rule cannot be understood, a parsing result cannot be presumed. Furthermore, when the number of correct solutions increases, the rule must be reformed by relearning the rule. However, an enormous amount of time is required to relearn the rule.

On the other hand, the method in Patent Document 1 proposes that syntax parsing assistance is performed by knowing the usage of a vocabulary included in an input sentence on the basis of a past syntax parsing result which is most similar to an input sentence. In the method, syntax parsing is not full-automatically performed. In addition, only one most similar sentence is used as the past syntax parsing result.

Furthermore, according to the proposal of Patent Document 1, in a comparing means (collation means), collation of sentences is performed one by one. For this reason, when a large number of examples, i.e., tens of thousands of examples are used, a speed at a practical level cannot be achieved in the comparison.

In order to solve the above problem, in Japanese Patent Laid-open Publication No. 2002-41512 (to be referred to as “Patent Document 2” hereinafter) proposes the following method. That is, translation pattern rules are formed on the basis of existing translated documents and stored as a dictionary, and syntax parsing is performed by using the dictionary, so that a translation result obtained by looking to the existing document (only a syntax parsing process can be performed by the same method).

According to the method proposed by Patent Document 2, although translation pattern rules formed on the basis of existing translated document are properly included in the syntax parsing results depending on an input sentence, all the formed translation pattern rules are treated on the same level with each other.

In this manner, since all the formed translation pattern rules are treated on the same level with each other, the information of a sentence provided to formation of the translation pattern rules is not reflected on ordering of a plurality of syntax parsing result candidates, and a syntax parsing result candidate which is not optimum may be determined as an optimum candidate.

If the sentence provided to formation of translation pattern rules is input as a sentence subjected to syntax parsing, even though a syntax parsing result candidate except for the syntax parsing result candidate to which the formed translation pattern rules are applied is obtained, the former cannot be necessarily valid.

For this reason, the information of the sentence provided to formation of natural language processing patterns can also be reflected on natural language processing such as syntax parsing for an input sentence, and a natural language processing apparatus, a natural language processing method, and a natural language processing program which can obtain optimum parsing results are desired.

### SUMMARY OF THE INVENTION

In order to the above problems, the first aspect of the invention provides a natural language processing apparatus which uses a pattern rule having at least a pattern name and a pattern constituent element to obtain a syntax parsing result of at least an input sentence, including: a with-sentence-ID pattern rule dictionary in which a pattern rule to which a sentence ID representing the probability of simultaneously applying a pattern rule to the same sentence is given is stored; a morphological parsing section for morphologically parsing an input sentence to be parsed; and a syntax parsing section which obtains a syntax parsing result constituted by a tree structure of a plurality of pattern rules with respect to a morphological parsing result with reference to the with-sentence-ID pattern rule dictionary and which employs a tree structure between pattern rules having pattern rules to which the same sentence ID is given and which increase in number.

The second aspect of the invention provides a natural language processing method which uses pattern rules having at least pattern names and pattern constituent elements to obtain a syntax parsing result of at least an input sentence, including: the morphological parsing step of preparing a with-sentence-ID pattern rule dictionary in which a pattern rule to which a sentence ID representing the probability of simultaneously applying a pattern rule to the same sentence is given is stored in advance and morphologically parsing an input sentence to be parsed; and the syntax parsing step of obtaining a syntax parsing result constituted by a tree structure of a plurality of pattern rules with respect to a morphological parsing result with reference to the with-sentence-ID pattern rule dictionary and employing a tree structure between pattern rules having pattern rules to which the same sentence ID is given and which increase in number.

In addition, the third aspect of the invention provides a natural language processing program writes the natural language processing method according to the second aspect of the invention in a code which can be executed by a computer.

### BRIEF DESCRIPTION OF THE DRAWINGS

FIG. 1 is a block diagram showing a functional configuration of a natural language processing apparatus according to the first embodiment.

FIG. 2 is a flow chart showing an operation of the natural language processing apparatus according to the first embodiment.

FIG. 3 is a diagram for explaining an example of an input sentence for a concrete explanation of processes performed in the first embodiment.

FIG. 4 is a diagram for explaining morphological parsing in the first embodiment for the input sentence in FIG. 3.

FIG. 5 is a diagram for explaining storage of a with-sentence-ID pattern rule dictionary in the first embodiment.

FIG. 6 is a diagram for explaining storage of a general-purpose pattern rule dictionary in the first embodiment.

FIG. 7 is a diagram for explaining a syntax parsing result obtained before a plurality of candidates of the first embodiment are canceled.

FIG. 8 is a diagram for explaining an example of a sentence ID counting table in the first embodiment.

FIG. 9 is a diagram for explaining an exception of a sentence ID counting method in the first embodiment.

FIG. 10 is a diagram for explaining a syntax parsing result obtained after a plurality of candidates in the first embodiment are canceled.

FIG. 11 is a block diagram showing a functional configuration of a natural language processing according to the second embodiment.

FIG. 12 is a flow chart showing an operation of the natural language processing according to the second embodiment.

FIG. 13 is a diagram for explaining storage of a with-sentence-ID translation pattern rule dictionary in the second embodiment.

FIG. 14 is a diagram for explaining storage of a general-purpose translation pattern rule dictionary in the second embodiment.

FIG. 15 is a diagram for explaining a syntax parsing result obtained before a plurality of candidates in the second embodiment are canceled.

FIG. 16 is a diagram for explaining an example of a sentence ID counting table in the second embodiment.

FIG. 17 is a diagram for explaining a syntax parsing result obtained after a plurality of candidates in the second embodiment are canceled.

FIG. 18 is a diagram for explaining a sentence generation result in the second embodiment.

FIG. 19A is a flow chart showing a syntax parsing process in the third embodiment.

FIG. 19B is a flow chart showing a syntax parsing process in the third embodiment.

FIG. 20A is a flow chart showing a syntax parsing process in the fourth embodiment.

FIG. 20B is a flow chart showing a syntax parsing process in the fourth embodiment.

FIG. 20C is a flow chart showing a syntax parsing process in the fourth embodiment.

### DETAILED DESCRIPTION OF THE PREFERRED EMBODIMENTS

(A) First Embodiment

The first embodiment of a natural language processing apparatus, a natural language processing method, and a natural language processing program according to the present invention will be described below. The first embodiment is to obtain a syntax parsing result for an input sentence.

(A-1) Configuration of First Embodiment

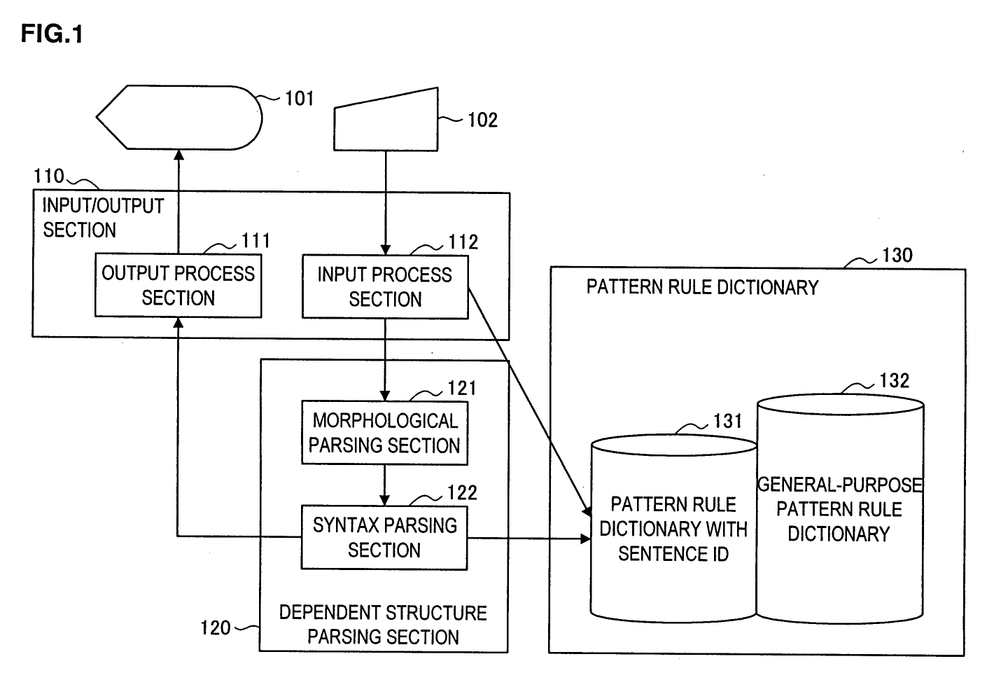

FIG. 1 is a block diagram showing a functional configuration of a natural language processing apparatus (syntax parsing apparatus) according to the first embodiment. Actually, for example, on an information processing device such as a personal computer, a natural language processing program (including fixed data) according to the first embodiment is loaded to construct a natural language processing apparatus according to the first embodiment (may be constructed as a single-purpose apparatus). The natural language processing apparatus can be functionally shown in FIG. 1.

In FIG. 1, the natural language processing apparatus according to the first embodiment roughly comprises an input/output section 110, a dependent structure parsing section 120, and a pattern rule dictionary 130.

The input/output section 110 comprises an input process section 112 which receives an input sentence from a input device 102 such as a keyboard or a file loading device, which receives correction information of a pattern rule dictionary obtained from a syntax parsing result of the input sentence, or which receives and registers a with-sentence-IC pattern rule dictionary 131, and an output process section 111 which outputs the syntax parsing result to a an output device 101 such as display, a printer, or a file storage device.

The dependent structure parsing section 120 is a process section for obtaining a syntax parsing result of an input sentence. The dependent structure parsing section 120 comprises a morphological parsing section 121 which divides words and which presumes parts of speech, and a syntax parsing section 122 which obtains a dependent structure of the divided words.

The pattern rule dictionary 130 comprises the with-sentence-IC pattern rule dictionary 131 and a general-purpose pattern rule dictionary 132.

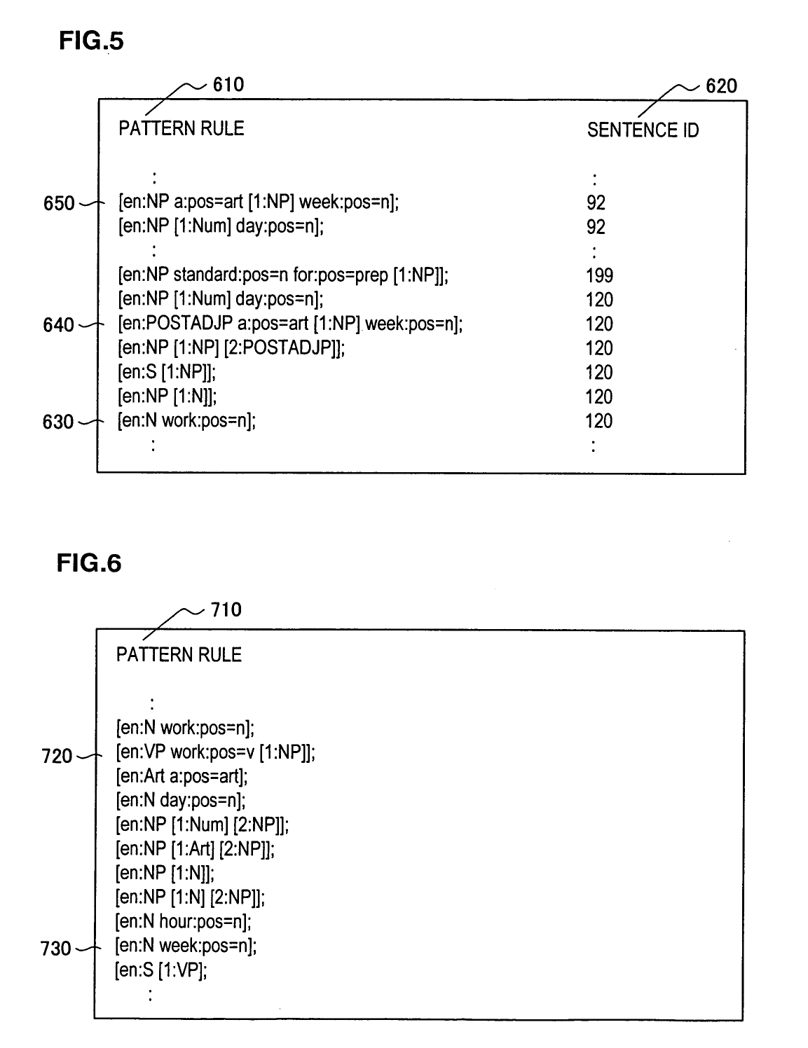

The with-sentence-IC pattern rule dictionary 131 stores pattern rules formed on the basis of the syntax parsing results of past documents which are desired by a user to be used as reference, and has sentence identification information (to be referred to as a sentence ID hereinafter) for representing a specific sentence in a specific document from which the pattern rule is derived (see FIG. 5 (to be described later)). A plurality of pattern rules having the same sentence ID are formed on the basis of the same sentence. Pattern rules stored in the with-sentence-IC pattern rule dictionary 131 are formed by, for example, the forming method described in Patent Document 2. At this time, the sentence IDs are given by a user or automatically given by the apparatus.

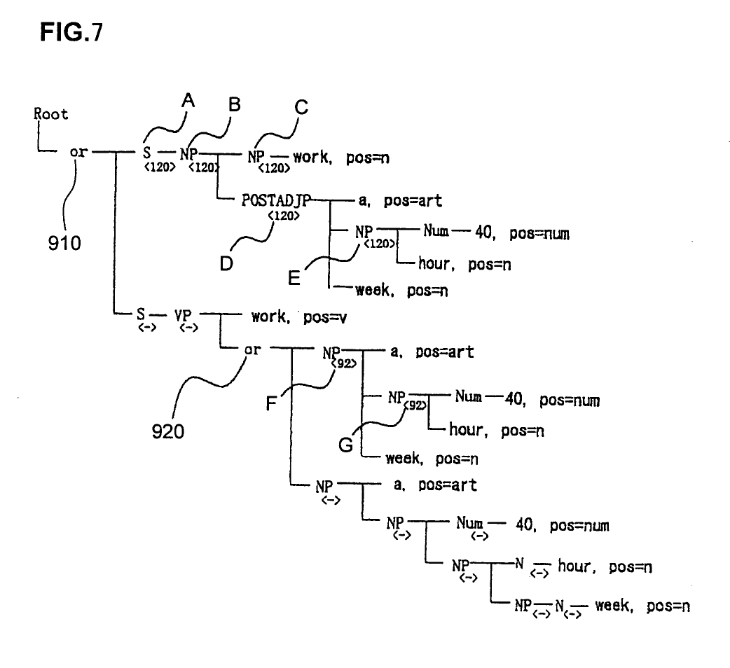

On the other hand, the general-purpose pattern rule dictionary 132 stores general-purpose pattern rules which are not dependent on a specific sentence, and are manually formed (see FIG. 6 (to be described later)). No sentence ID is not given to the general-purpose pattern rule.

(A-2) Operation of First Embodiment

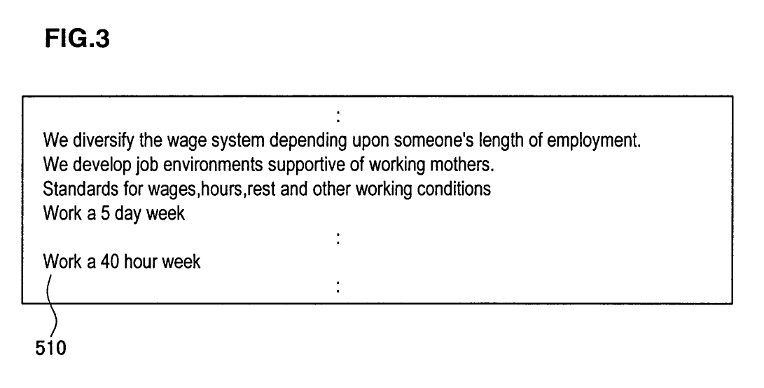

An operation (natural language processing method according to the first embodiment) of the natural language processing apparatus according to the first embodiment will be described below. In the following description, a concrete explanation is performed on the assumption that an input document properly includes a sentence: “work a 40 hour week” (see 510 in FIG. 3) to perform syntax parsing for the sentence.

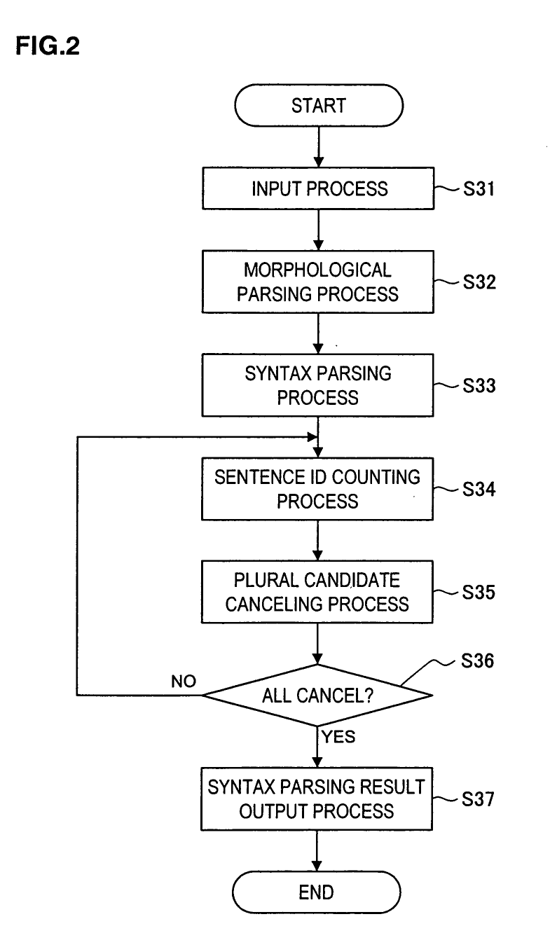

FIG. 2 is a flow chart showing an operation (syntax parsing process) of the natural language processing apparatus according to the first embodiment.

A user inputs a sentence from the input process section 112 by using the input device 102 such as a keyboard (S31). The input process section 112 gives the input sentence to the morphological parsing section 121. The morphological parsing section 121 morphologically parses the sentence (S32) to give the resultant sentence to the syntax parsing section 122. The syntax parsing section 122 performs syntax parsing of the morphological parsing result (S33). The morphological parsing process and the syntax parsing process will be described below.

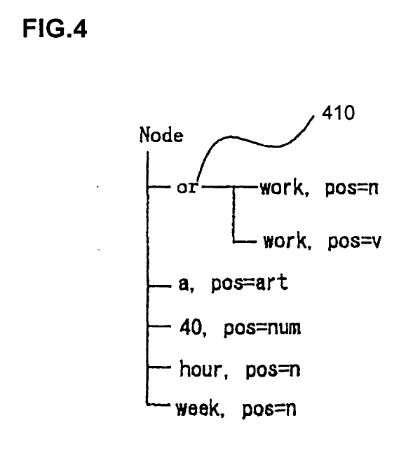

In the morphological parsing section 121, a sentence is divided into words, and information of parts of speech and inflections are given to the words (as in Patent Document 2). The morphological parsing result is expressed by a tree structure in which a root node is represented by “Node”. In a morpheme which does not have a plurality of candidates, standard forms of morphemes and morpheme information such as parts of speech or inflections are given to portions immediately below the root nodes. On the other hand, in a morpheme which has a plurality of candidates, pieces of information of morpheme candidates are given as subsidiary nodes of or nodes. FIG. 4 shows a morphological parsing result for the input sentence “work a 40 hour week”. When the morphological parsing result has a plurality of candidates, as shown in FIG. 4, all the candidates are obtained (see reference numeral 410). In FIG. 4 or the like, “pos=” represents part-of-speech information, “n” represents a noun, “v” represents a verb, and “art” represents an article.

The syntax parsing section 122 applies the pattern rules stored in the pattern rule dictionary 130 to a morphological parsing result in a bottom-up manner to obtain a set (tree structure) of pattern rules constituting input sentences, thereby performing syntax parsing. This is almost the same as the operation performed in Patent Document 2. In the operation in Patent Document 2, an “evaluation process of pattern” is performed. However, in the first embodiment, as will be described later, competition of the syntax parsing result candidates is canceled. For this reason, the “evaluation process of pattern” as described in Patent Document 2 is not executed.

FIG. 5 is a diagram for explaining storage of the with-sentence-IC pattern rule dictionary 131, and shows a pattern rule 610 related to the input sentence described above. A sentence ID 620 is related to the pattern rule 610. FIG. 6 is a diagram for explaining storage of the general-purpose pattern rule dictionary 132, and shows a pattern rule 710 related to the input sentence described above.

Both the pattern rules 610 and 710 are notated by the same notation system. In syntax parsing, the pattern rules 610 and 710 are applied without being discriminated. The pattern rule is constituted by [language name: pattern name, pattern component]. The language name regulates a language name related to the pattern rule, and regulates English (en) in FIGS. 5 and 6. The language name may be omitted when the pattern rule is used in syntax parsing in a predetermined language. As the pattern name subsequent to the language name, for example, a sign such as VP (verb phrase), NP (noun phrase, or N (noun) in a phrase structure rule is applied. The pattern component is constituted by a word, a variable, or an array consisting of at least two components. The variable is described by [arbitrary number: pattern name (corresponding to a lower node of a tree structure). The arbitrary numerical component represents a relationship between an original language pattern and a target language pattern which are paired for a translation process (see the second embodiment). In the syntax parsing, another pattern is applied to the variable, so that the patterns can be arranged in a nested structure (variables are canceled). In addition, a word and a pattern name can have detailed information (background information) such as meaning information. Furthermore, the pieces of detailed information of the word and the pattern name are made variable, and can be referred to.

The syntax parsing section 122 repeatedly perform three processes, i.e., a pattern dictionary look-up process, a pattern inspection process, and a pattern application process while checking that syntax parsing is not ended to form a tree structure of a syntax parsing result (candidate).

The pattern dictionary looking process is a process of looking up a pattern rule which may be applied next in the pattern rule dictionary 130 on the basis of the morphological parsing result and results of the pattern applying process which has been performed. A pattern examination process is a process of examining whether the pattern rule obtained by looking in the dictionary is matched with a tree structure which is being constructed for each tree structure. The pattern applying process is a process of actually applying the pattern rule to a tree structure on the basis of the tree structure determined as a matched tree structure and the pattern rule.

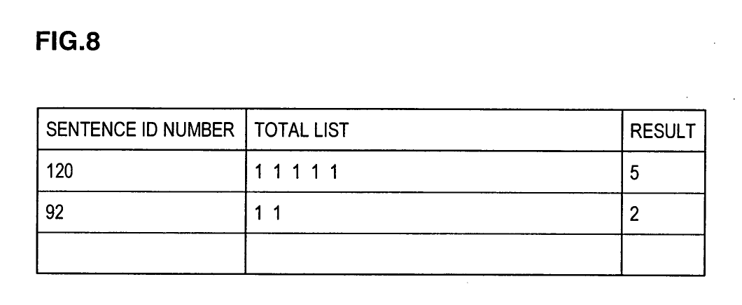

FIG. 7 shows a syntax parsing result (candidate) obtained by applying the pattern rule as shown in FIGS. 5 and 6 to the morphological parsing result shown in FIG. 4. In many cases, the syntax parsing result is not uniquely determined and includes a plurality of syntax parsing result candidates by “or” nodes 910, 920. In this case, in the syntax parsing result (candidate) as shown in FIG. 7, when the applied pattern rule is a pattern rule with sentence ID, the sentence ID is also given as information of a corresponding node of the tree structure. In addition, when pattern rules which are equal to each other except for given sentence IDs are stored in the with-sentence-IC pattern rule dictionary 131 and the general-purpose pattern rule dictionary 132, respective, the pattern rule stored in the with-sentence-IC pattern rule dictionary 131 is preferentially used.

After the syntax parsing result (candidate) is obtained, a plurality of candidates using sentence IDs are canceled (narrow down to one candidate) (S34 to S36).

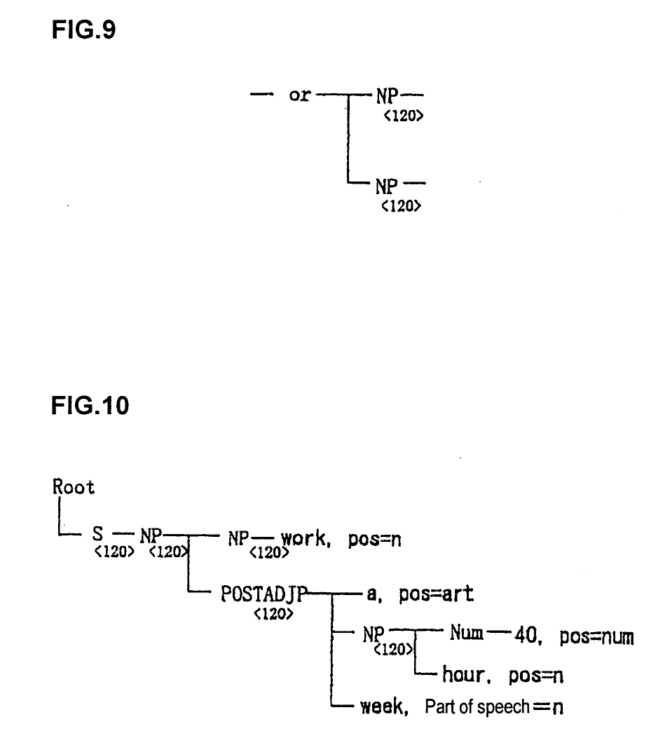

The sentence IDs of pattern rules constituting a parsing result in the entire tree structure of the syntax parsing result (candidate) shown in FIG. 7 are counted by using a sentence ID counting table (a kind of buffer memory) built in the syntax parsing section 122 and shown in FIG. 8 (S34).

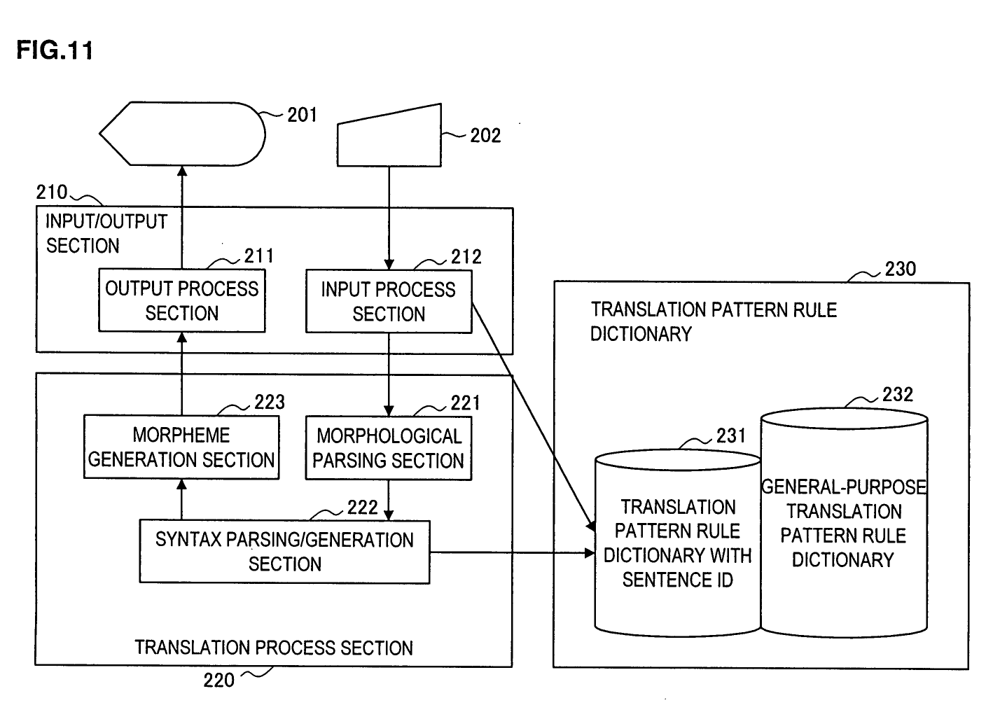

As shown in FIG. 9, when two pattern rules immediately below “or” node have the same pattern name and the same sentence number (in other words, when a plurality of sentence IDs exist between disjunctive parsing results), the pattern rules are counted as one to avoid double counting.

In the syntax parsing result (candidate) in FIG. 7, since pattern rules each having a sentence ID “120” are five pattern rules A, B, C, D, and E, “5” is set in the column of the result of “120” in the sentence ID counting table in FIG. 8. On the other hand, since pattern rules each having a sentence ID “92” are two pattern rules F and G, “2” is set in the column of the result of “92”. Since “<->” in FIG. 9 represents a general-purpose pattern rule, the pattern rule has no sentence ID. Therefore, the pattern rule is not subjected to the counting process. In this manner, a result described in a sentence ID counting table shown in FIG. 8 is obtained.

A sentence ID having the maximum count number in the table is selected, and a syntax parsing result candidate having pattern rules which have the sentence ID and the number of which is maximum is selected as a (final) syntax parsing result (S35). In the example in FIG. 8, since the count number of the sentence ID “120” is maximum, a syntax parsing result candidate having pattern rules A to E is selected from the syntax parsing result candidate (parsing tree) in FIG. 7.

Thereafter, it is checked whether the selected syntax parsing result includes a plurality of candidates (disjunctive parts) or not. If the selected syntax parsing result does not include a plurality of candidates (disjunctive parts), a series of canceling processes are ended (S36).

The example in FIG. 7 has the pattern rules A to E, there are no candidates when the syntax parsing result candidate is selected. For this reason, the canceling process is ended.

On the other hand, in the process in step S35, the selected syntax parsing result includes a plurality of candidates, the counting process for sentence IDs again except for the sentence ID of the predetermined pattern rules (S34), the canceling process of the plurality of candidates is repeated (S35). For example, when “or” nodes exist on a plurality of stages, a process loop constituted by steps S34 to S36 is repeated.

When all the candidates are fixed to cancel the plurality of candidates (S36), the dependent structure parsing section 120 gives the syntax parsing result to the output process section 111, and causes the output device 101 such as a CRT display to output the syntax parsing result (S37), and the syntax parsing process is ended.

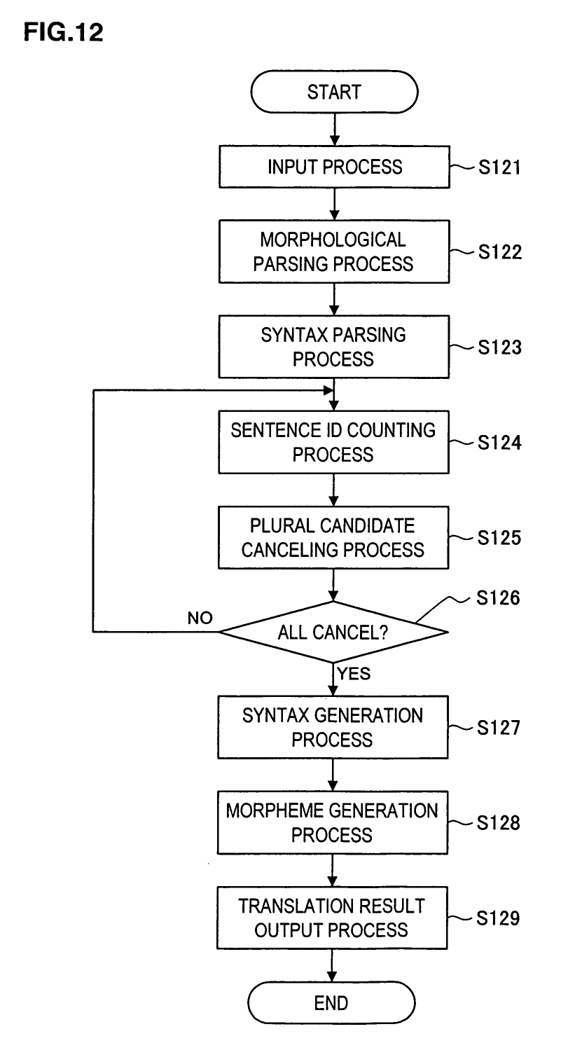

FIG. 10 shows a final syntax parsing result obtained by performing a canceling process of a plurality of candidates to the syntax parsing result candidates shown in FIG. 7.

In the syntax parsing result obtained by the syntax parsing process in step S33, a pattern rule with sentence ID is not applied, and all the pattern rules are general-purpose pattern rules. When the syntax parsing result has a plurality of candidates, a canceling process of another plurality of candidates is performed. For example, the method described in Patent Document 2 can be applied. Even though a plurality of sentence IDs have the maximum count numbers, for example, the canceling process of a plurality of candidates described in Patent Document 2 can be applied.

(A-3) Effect of First Embodiment

According to the first embodiment, the following effect can be achieved.

Since, after the correct syntax parsing result is obtained, pattern rules with sentence ID formed on the basis of the correct syntax parsing result are used, the accuracy of the syntax parsing can be improved. More specifically, a plurality of pattern rules obtained on the basis of the parsing result of the same sentence can be included in a parsing result of a new sentence, and the accuracy of the syntax parsing can be improved.

For example, when a parsing result of a sentence “work a 5 day week” which is arranged before a sentence “work a 40 hour week” in FIG. 3 and which is of the same type as that of the sentence is presented, a user cannot be satisfied by the parsing result and forms a pattern rule (pattern rule with sentence ID). In this case, the syntax parsing of the sentence “work a 40 hour week”, a pattern rule with sentence ID on which the parsing result of the sentence “work a 5 day week” is reflected is applied, and a preferable syntax parsing result is obtained as the syntax parsing result of the sentence “work a 40 hour week”.

A process of repeating the process loop consisting of the processes in steps S34 to S36 described above can also cause pattern rules having a plurality of sentence IDs to be applied. When past parsing results are reflected, at least past parsing results can be reflected on a parsing result of the current input sentence.

In addition, since both a pattern rule with sentence ID formed by past cases and a general-purpose pattern rule formed which is manually formed from the beginning are used, even if a small number of cases can be applied, the syntax parsing process can be executed.

(B) Second Embodiment

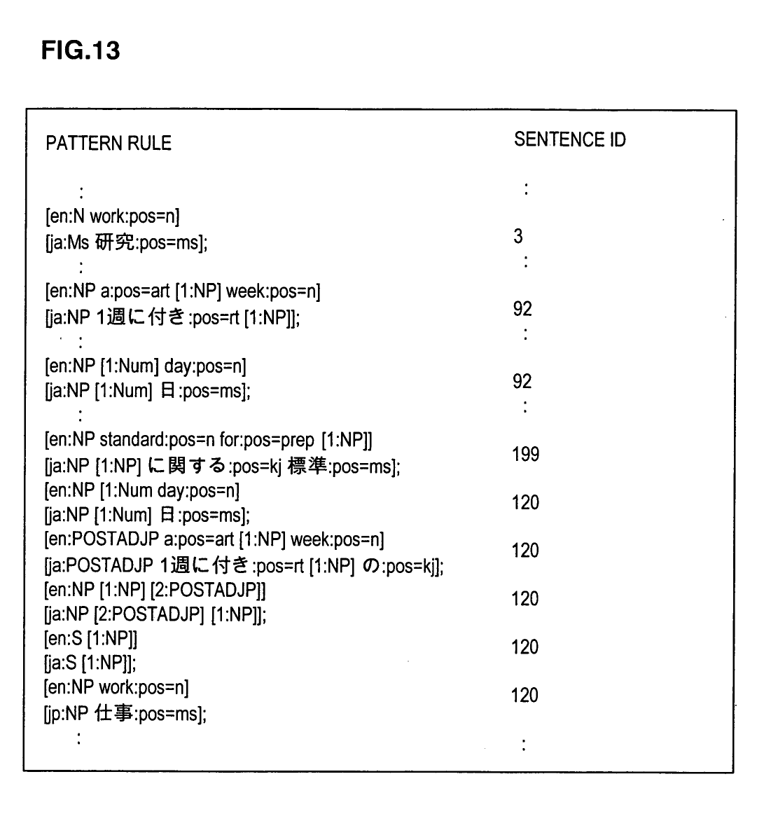

The second embodiment of a natural language processing apparatus, a natural language processing method, and a natural language processing program according to the present invention will be described below with reference to the accompanying drawings. Actually, for example, a natural language processing program (including fixed data) according to the second embodiment is loaded on an information processing device such as a personal computer to construct the natural language processing apparatus according to the second embodiment (may be constructed as a single-purpose apparatus). The natural language processing apparatus can be functionally shown in FIG. 11.

(B-1) Configuration of Second Embodiment

FIG. 11 is a block diagram showing a functional configuration of a natural language processing apparatus (mechanical translation apparatus) according to the second embodiment. Actually, for example, on an information processing device such as a personal computer, a natural language processing program (including fixed data) according to the second embodiment is loaded to construct a natural language processing apparatus according to the second embodiment (may be constructed as a single-purpose apparatus). The natural language processing apparatus can be functionally shown in FIG. 11.

In FIG. 11, the natural language processing apparatus according to the second embodiment roughly comprises an input/output section 210, a translation process section 220, and a translation pattern rule dictionary 230.

An output device 201 and an input device 202 are substantially the same as the output device 101 and the input device 102 according to the first embodiment. The input/output section 210 comprises an output process section 211 and an input process section 212. The output process section 211 and the input process section 212 are substantially the same as the output process section 111 and the input process section 112 according to the first embodiment.

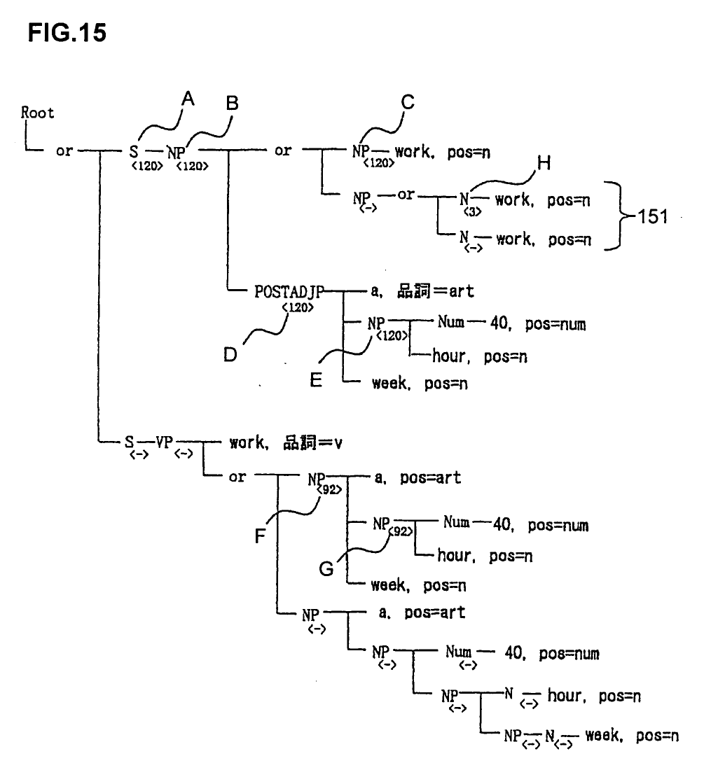

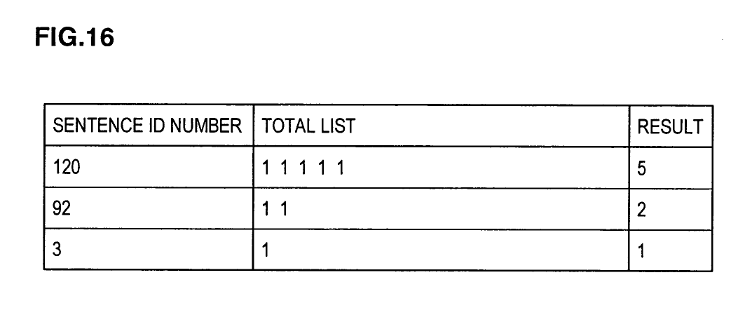

The input/output section 210 and the translation pattern rule dictionary 230 are almost the same as those in the first embodiment. The translation pattern rule dictionary 230 according to the second embodiment is based on the pattern rule dictionary of the first embodiment. However, rules stored in the pattern rule dictionary are pattern rules (translation pattern rules) consisting of a two-language pair. FIG. 13 shows storage of a with-sentence-ID translation pattern rule 231 in the translation pattern rule dictionary 230. FIG. 14 shows storage of a general-purpose translation pattern rule 232 in the translation pattern rule dictionary 230. In the with-sentence-ID translation pattern rule 231, a sentence ID is given to a pair of translation pattern rules consisting of a two-language pair.

The translation process section 220 comprises a morphological parsing section 221, a syntax parsing/generation section 222, and a morpheme generation section 223.

The morphological parsing section 221 is the same as that in the first embodiment. A syntax parsing function in the syntax parsing/generation section 222 is the same as the function in the syntax parsing section in the first embodiment. A syntax generation function in the syntax parsing/generation section 222 is a function which perform a generation process based on a pair of pattern rules of a target language. The morpheme generation section 223 regulates the inflection and conjugation of words in the target language. The translation process section 220 is almost the same as the translation process section described in Patent Document 2 except for the canceling process of a plurality of candidates of a syntax parsing result in an original language.

(B-2) Operation of Second Embodiment

An operation (natural language processing method according to the second embodiment) of the natural language processing apparatus according to the second embodiment. In the following description, an input document properly includes a sentence “work a 40 hour week” (see 510 in FIG. 3). Concrete explanation is performed such that the sentence is mechanically translated.

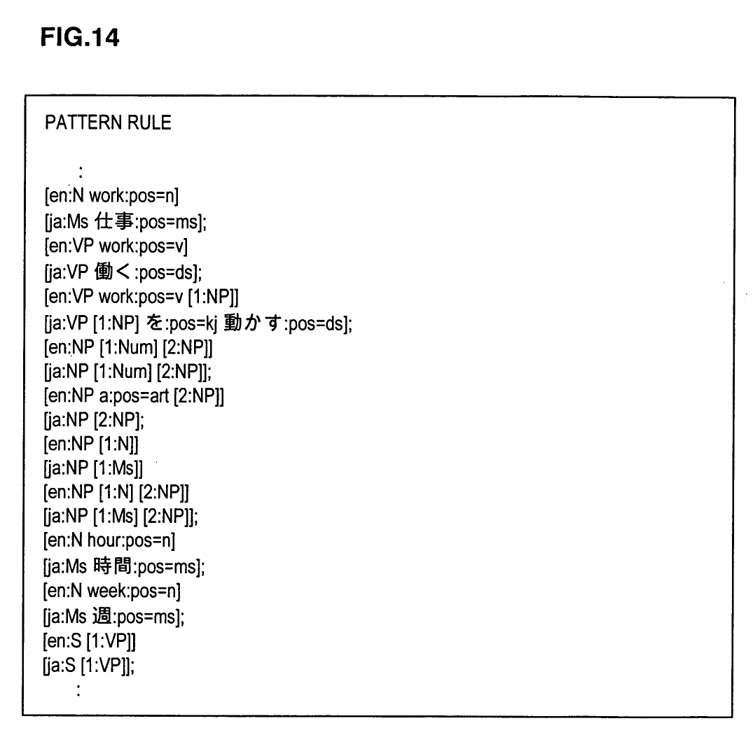

FIG. 12 is a flow chart showing an operation (mechanical translation process) of the natural language processing apparatus according to the second embodiment.

An input process (S121) and a morphological parsing process (S 122) according to the second embodiment are the same as those in the first embodiment. For this reason, the detailed explanation of these processes will be omitted.

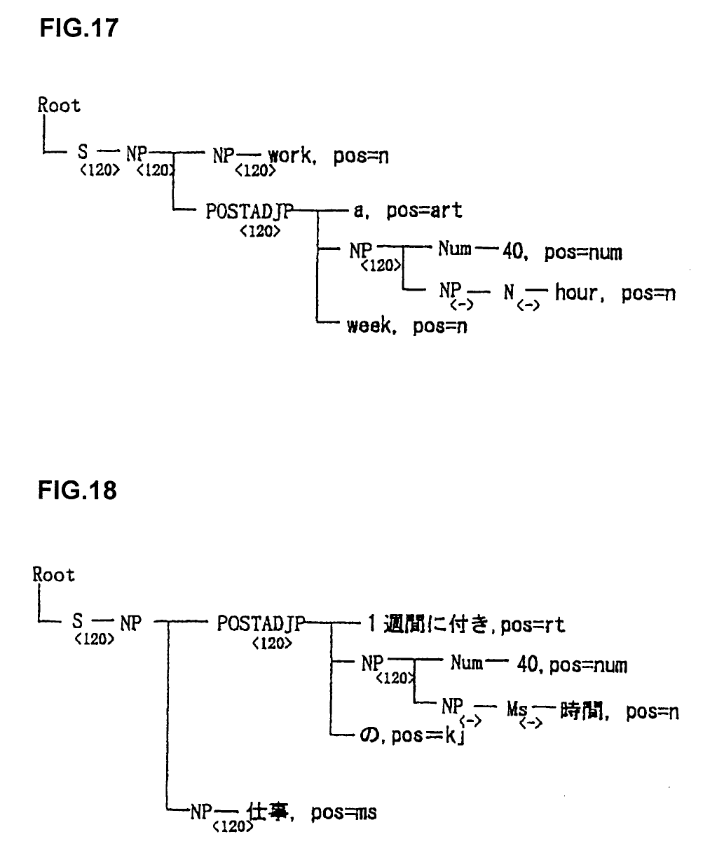

A syntax parsing process (S123) is almost the same as that in the first embodiment except for the following point. Pattern rules used in the syntax parsing process are a pair of translation pattern rules consisting of an English pattern rule and a Japanese pattern rule as shown in FIG. 13 and FIG. 14. Syntax parsing of an input sentence is performed by pattern rules on an original language side to obtain a syntax parsing result in a target language (translation side) at the same time (see Patent Document 2). A result obtained by performing syntax parsing to the morphological parsing result (FIG. 4) of the input sentence by the translation pattern rules shown in FIGS. 13 and 14 is shown in FIG. 15. FIG. 15 is different from FIG. 7 in the first embodiment in that, in addition to a plurality of candidates related to a syntax, a plurality of candidates related to translated words indicated by reference numeral 151 appear. More specifically, the syntax parsing process in step S123, even though the same pattern rule is used on the original language side, when a different pattern rule is used in a translated word, it is made apparent that the different pattern rule is used in the translated word, and the pattern rules in the original language are included in the syntax parsing tree (pattern rule H having a sentence ID “3”).

However, the plurality of candidates of the syntax are also canceled by using a sentence ID counting table as in the first embodiment.

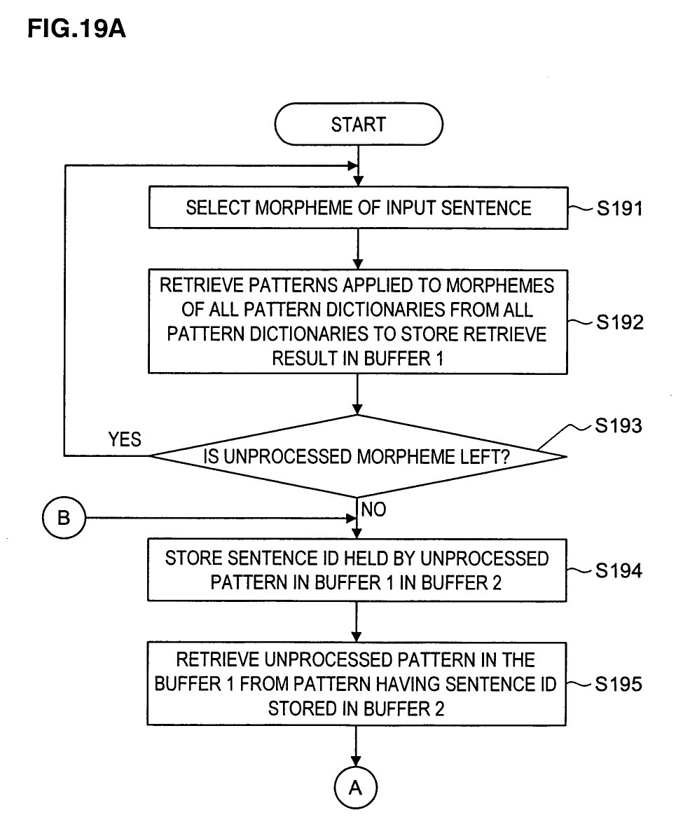

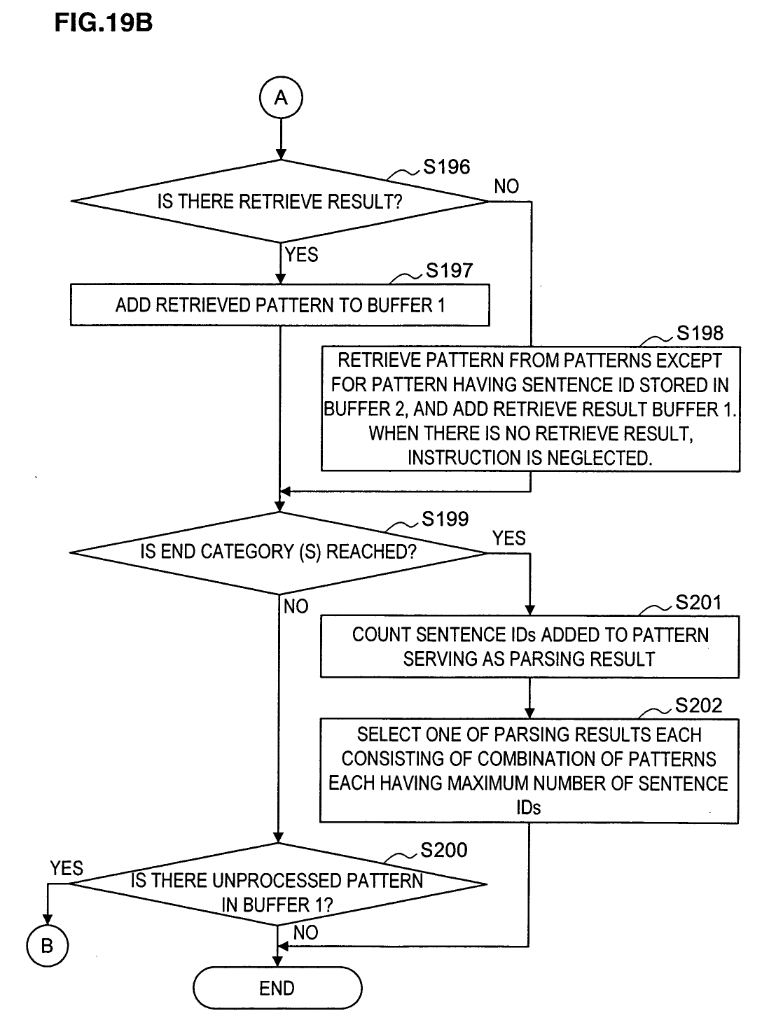

Upon completion of the syntax parsing process to the morphological parsing result, a sentence ID counting process is performed (S124). For the syntax parsing result shown in FIG. 15, a sentence ID counting process shown in FIG. 16 is formed. Since the number of results of a sentence ID “120” is maximum, i.e., five, the translation pattern rules of the sentence ID “120” are employed (S125). As a result, as shown in FIG. 17, a syntax parsing result candidate including a maximum number of translation pattern rules each having the sentence ID “120” as shown in FIG. 17 is obtained.

Since a plurality of candidates do not exist in FIG. 17 (S126), the next process is performed. As in the first embodiment, a process loop consisting of the processes in steps S124 to S126 is repeatedly executed until the plurality of candidates are canceled.

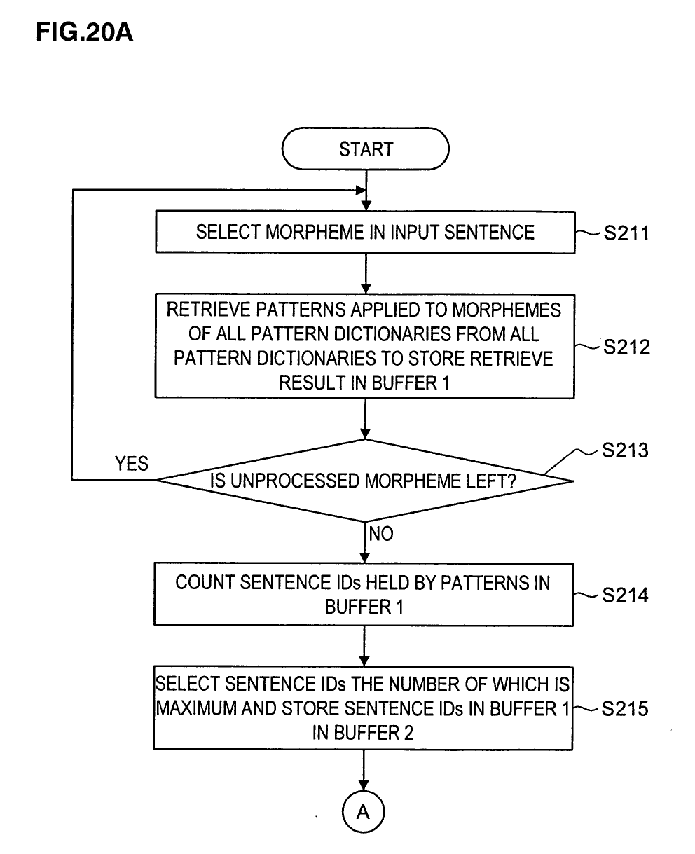

When the plurality of candidates are canceled by the repeat process of the process loop consisting of the processes in steps S124 to S126, a syntax parsing result in the original language is obtained, and, at the same time, a syntax parsing result in the target language as shown in FIG. 18 is also obtained. In FIG. 12, the syntax generation process is described as an independent step. However, a syntax generation process for generating a syntax parsing result in the target language is executed in almost parallel with the process of obtaining a syntax parsing result in the original language (S 127).

In the syntax parsing generation process, with reference to the translation pattern rule dictionary 230, by using a pattern in a target language (Japanese) paired with a pattern of the original language, a tree structure in Japanese corresponding to the syntax parsing result (see Patent Document 2). The translation pattern consists of a pair of an original language pattern and a translation pattern, and the relationship therebetween is uniquely determined. For this reason, actually, a syntax parsing process and a syntax generation process are parallel executed.

A morpheme generation process is performed on the tree structure (syntax generation result) in the target language (S128) to obtain a final translation result. The translation result is output by the output device 201 such as a CRT display (S129). In the morpheme generation process, as the syntax generation results, Japanese words located at a terminal node are sequentially arranged from the left, the words are regulated such that conjugational verbs are regulated by using a target language morpheme dictionary (not shown).

For example, with respect to an original sentence “work a 40 hour week”, a translation result [Shu 40 jikan no shigoto] is obtained.

(B-3) Effect of Second Embodiment

According to the second embodiment, in addition to the same effect as in the first embodiment, the following result is obtained.

A translation pattern rule with sentence ID formed on the basis of past translation cases is applied to perform syntax parsing, cancellation of a plurality of candidates using sentence IDs is performed to the syntax parsing result which is temporarily obtained, cancellation of a plurality of candidates of the syntax and cancellation of a plurality of candidates of the translated word can be simultaneously performed.

Without using an existing document which is parallel translated in units of sentences, by using past translated sentences which are partially decomposed as translation pattern rules, the chance of using the existing parallel translated document can be increased. When the past translated sentences are partially decomposed and used, a wrong combination is disadvantageously obtained because there is information of the relationship between the parts. However, by using sentence ID information, in combination, a mechanism for reproducing a past translated sentence works. For this reason, a more preferable combination is selected.

In a general example-leading-type translation scheme serving as a translation scheme based on cases, a sentence which is most similar to an input sentence is found from past translated instructive sentences, a difference (different portion) there between is extracted. The difference is mechanically translated and replaced with the original translated instructive sentence. For this reason, a method including a large number of process steps is employed. In the method according to the second embodiment, a part to which an employed sentence ID is given corresponds to the difference, a result similar to a result obtained by the example-leading-type translation can be achieved by only the syntax parsing process.

(C) Third Embodiment

The third embodiment of a natural language processing apparatus, a natural language processing method, and a natural language processing program will be described below with reference to the accompanying drawings. The third embodiment is made to obtain a syntax parsing result for an input sentence.

The natural language processing apparatus (syntax parsing apparatus) according to the third embodiment is constructed by loading the natural language processing program (including fixed data) according to the third embodiment on an information processing device such as a personal computer (may be constructed as a single-purpose apparatus). The natural language processing apparatus can be functionally shown in FIG. 1 according to the first embodiment.

The natural language processing apparatus according to the third embodiment is different from that of the first embodiment in the process in the syntax parsing section 122.

In the first embodiment, a sentence ID is not used when a syntax parsing result (syntax parsing tree) as shown in FIG. 7, and a sentence ID is used in cancellation of a plurality of candidates in a syntax parsing tree. The third embodiment intends to achieve the following objects. That is, a sentence ID is also used in a process of forming a syntax parsing tree to make it possible to execute syntax parsing at a high speed, and, when the syntax parsing tree is obtained, a plurality of candidates can be prevented from being generated as much as possible.

In the third embodiment, a bottom-up method applies an upper pattern rule which satisfies the conditions of a lower pattern rule to construct a syntax parsing tree. However, a new pattern rule is applied, syntax parsing is performed such that a pattern rule (upper pattern rule) having the same sentence ID as the sentence ID held by the new pattern rule is preferentially selected, so that a retrieval space of the pattern rule to be applied is narrowed. In this manner, high-speed processes and elimination of a plurality of candidates are achieved.

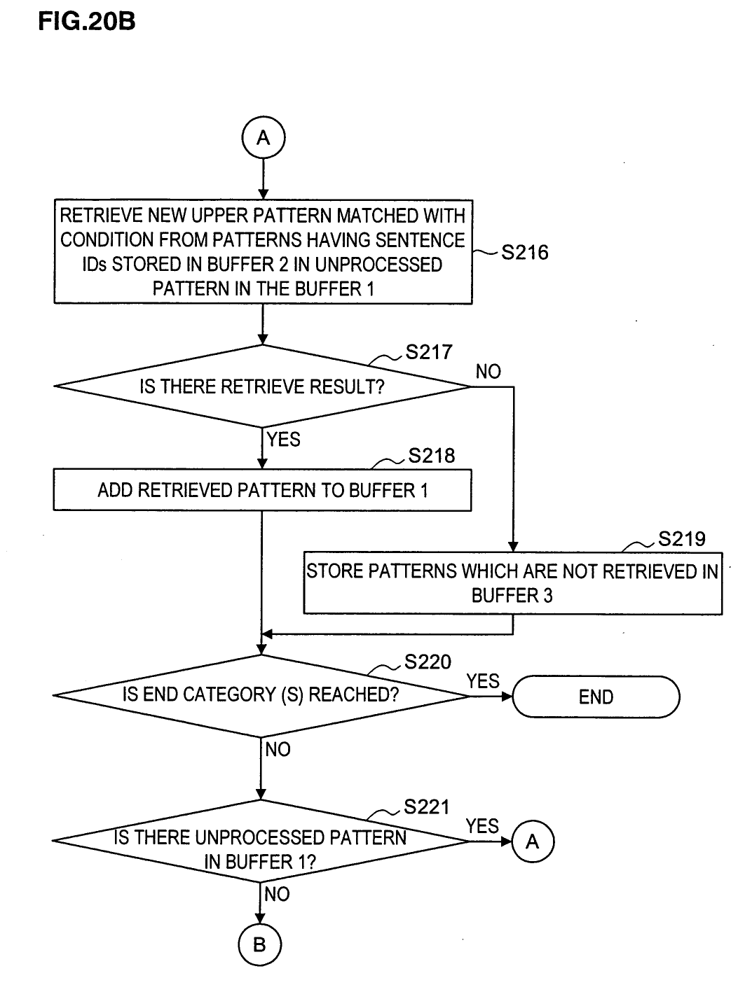

FIGS. 19A and 19B show a flow chart showing a syntax parsing tree (corresponding to S33 to S36 in FIG. 2) in the third embodiment. FIGS. 19A and 19B show a flow of processes with emphasis on use of sentence IDs. A syntax parsing section 122 is built in each of a buffer 1 and a buffer 2 in FIGS. 19A and 19B.

One unprocessed morpheme is selected from a morphological parsing result (S191), a pattern rule applied to the morpheme is retrieved from the pattern rule dictionary 130, and a retrieval result is stored in the buffer 1 (S192). Such process is repeated for all morphemes of the morphological parsing result (S193). In this case, when the same pattern rules having different sentence IDs are stored in the with-sentence-IC pattern rule dictionary 131 and the general-purpose pattern rule dictionary 132, respectively, the pattern rule stored in the with-sentence-IC pattern rule dictionary 131 is preferably stored in the buffer 1.

For example, the processes in steps S191 to S193 are repeated in units of morphemes “work, pos=n”, “work, pos=v”, . . . in FIG. 4. With respect to the morpheme “work, pos=n”, a pattern rule indicated by reference numeral 630 in FIG. 5 is stored in the buffer 1. With respect to the morpheme “work, pos=v”, a pattern rule indicated by reference numeral 720 in FIG. 6 is stored in the buffer 1.

When retrieval of pattern rules for all the morphemes is ended, retrieval of related pattern rules (mainly, upper pattern rules) in steps subsequent to step S194 is started.

In the retrieval of the related pattern rules, one unprocessed pattern rule in the buffer 1 is used as a target to be processed, and the sentence ID held by the pattern rule is stored in the buffer 2 (S194). As a related pattern rule of the unprocessed pattern rule, pattern rule is retrieved from pattern rules having sentence IDs stored in the buffer 2 (S195). When a sentence ID is given to the unprocessed pattern rule of a target to be processed, storage of the sentence ID in the buffer 2 is omitted, or a meaning less value is stored in the buffer 2 (S194). As an unprocessed pattern rule serving as a target to be processed in step S194, not only a pattern rule stored in the step S192, but also a pattern rule stored in steps S197 or S198 (to be described later) may be used.

For example, when a pattern rule with reference numeral 630 in FIG. 5 is a target to be processed, a pattern rule having a sentence ID 120 is a target to be retrieved.

Thereafter, it is checked whether a related pattern rule having a sentence ID stored in the buffer 2 can be retrieved or not (S196). When the related pattern rule can be retrieved, the retrieved related pattern rule is added to the buffer 1 (S197). In this addition, relationship information such as hierarchical relation information between pattern rules is also stored. On the other hand, when the related pattern rule having the corresponding sentence ID cannot be retrieved, the related pattern rule is retrieved from pattern rules which do not have the sentence ID, and the retrieved related pattern rule is added to the buffer 1 (S198). When the related pattern rule cannot be retrieved in the retrieval, this result is neglected, and the next process is started. When the retrieval result is stored in the buffer 1 in steps S197 or S198, pattern rules stored in the buffer 1 except for the pattern rule serving as the target to be processed include a pattern rule which is connected to the currently retrieved related pattern rule and automatically determined as a processed pattern rule.

It is checked whether the currently retrieved related pattern rule is an end category (pattern rule related to S (sentence)) (S199).

When the retrieval does not reach the end category, it is checked whether an unprocessed pattern rule which is not subjected to retrieval of the related pattern rule is left in the buffer 1 or not (S200). If YES in step S200, the control flow returns to step S194. If NO in step S200, it is determined as a syntax parsing failure, and a series of processes are ended.

When the retrieval of the related pattern rule reaches the end category, as in the first embodiment, a plurality of candidates are canceled depending on the number of sentence IDs included in the syntax parsing tree. The syntax parsing results are narrowed down to one syntax parsing result, and the series of processes are ended (S201 and S202).

According to the third embodiment, in addition to the effect as that in the first embodiment, the following effect can be obtained. That is, in construction of the syntax parsing tree, a related pattern rule (upper pattern rule) having the same sentence ID as the sentence ID held by a lower pattern rule is preferentially selected, a retrieval space for pattern rules to be applied becomes narrow, and high-speed processes and elimination of a plurality of candidates are achieved.

(D) Fourth Embodiment

The fourth embodiment of a natural language processing apparatus, a natural language processing method, and a natural language processing program will be described below with reference to the accompanying drawings. The fourth embodiment is made to obtain a syntax parsing result for an input sentence.

The natural language processing apparatus (syntax parsing apparatus) according to the fourth embodiment is also constructed by loading the natural language processing program (including fixed data) according to the fourth embodiment on an information processing device such as a personal computer (may be constructed as a single-purpose apparatus). The natural language processing apparatus can be functionally shown in FIG. 1 according to the first embodiment.

The natural language processing apparatus according to the fourth embodiment is different from that of the first embodiment in the process in the syntax parsing section 122.

Like the third embodiment, the fourth embodiment intends to achieve the following object. That is, a sentence ID is used even in the process of forming a syntax parsing tree to make it possible to execute syntax parsing at a high speed, and, when the syntax parsing tree is obtained, a plurality of candidates can be prevented from being generated as much as possible.

In syntax parsing using pattern rules, a bottom-up method is employed, first, application of a pattern rule including a vocabulary (morpheme) is started. In the fourth embodiment, pattern rules each having the same sentence ID are preferentially applied, and the following method is used. That is, a sentence ID to be preferentially applied is determined in advance in application of pattern rules including the vocabulary, and a pattern rule having the sentence ID is preferentially applied in retrieval of a related pattern rule (mainly, upper pattern rule). This is because, the sentence ID to be preferentially applied is predicted by only check of a pattern rule related to the vocabulary.

In the fourth embodiment, application of a pattern rule including any one of all vocabularies is determined first, and a sentence ID which is applied to a largest number of pattern rules is selected (several sentence IDs may be selected). Subsequently, the pattern rules having the selected sentence ID are preferentially applied. When a sentence ID to be retrieved is regulated by pattern rules related to vocabularies in advance, a retrieval space can be narrowed. For this reason, a high-speed operation can be expected, and a plurality of candidates can be almost prevented from being generated when a syntax parsing tree is formed.

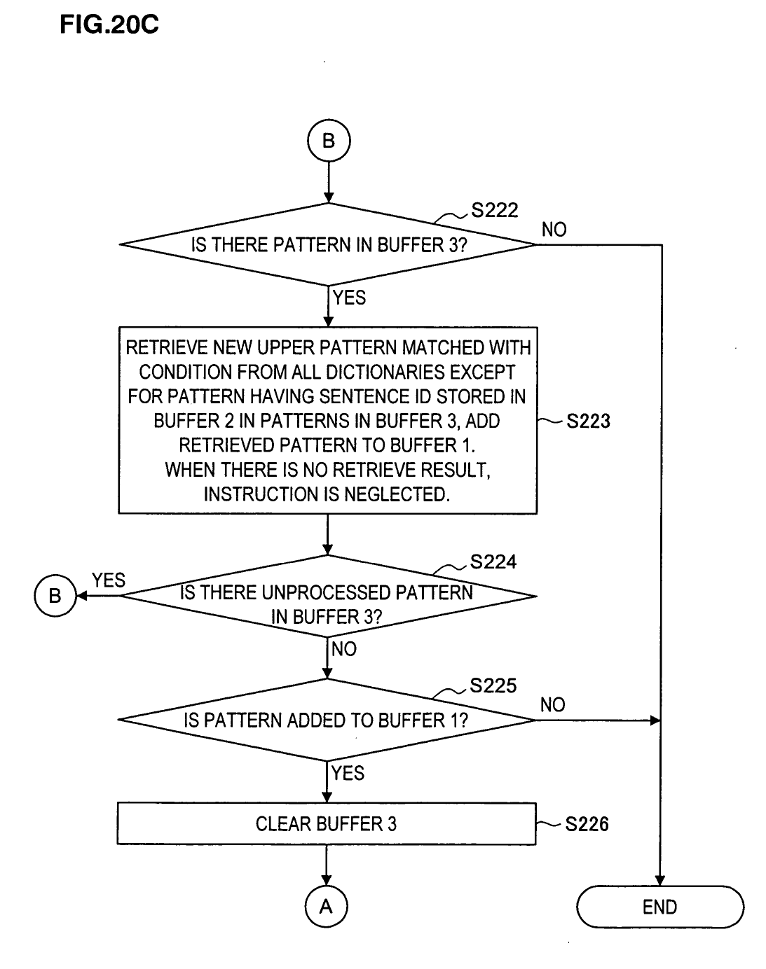

FIGS. 20A, 20B, and 20C show a flow chart showing a syntax parsing process (corresponding to steps S33 to S36) in the fourth embodiment. FIGS. 20A, 20B, and 20C show a flow of processes with emphasis on use of sentence IDs. A syntax parsing section 122 is built in each of a buffer 1 and a buffer 2. Buffers 1 to 3 in FIGS. 20A, 20B, and 20C are built in the syntax parsing sections 122.

Pattern rules applied to all the morphemes of the syntax parsing result are retrieved from the pattern rule dictionary 130, and the retrieval result is stored in the buffer 1 (S211 to S213). These are the same as those in the third embodiment.

Sentence IDs given to pattern rules applied to morphemes (vocabulary) stored in the buffer 1 are counted in units of sentence IDs, and a sentence ID applied to a maximum number of pattern rules is stored in the buffer 2 (S214 and S215).

For example, when the above input sentence is “work a 40 hour week”, a pattern rule according to reference numerals 630 and 640 in FIG. 5 is a pattern rule applied to a morpheme (vocabulary). Pattern rules each having the sentence ID “120” are most frequently applied, and 120 is stored in the buffer 2.

Upon completion of storage of the sentence ID in the buffer 2, retrieval of a related pattern rule later step S216 (mainly upper pattern rule) is started.

In the retrieval of the related pattern rule, one unprocessed pattern rule in the buffer 1 is used as a target to be processed, and the related pattern rule of the unprocessed pattern rule is retrieved from pattern rules having sentence IDs stored in the buffer 2. It is checked whether the related pattern rule can be retrieved or not (S216 and S217). More specifically, when a sentence ID is given to the unprocessed pattern rule to be processed, or even though different sentence IDs are given to the pattern rules, retrieval using the sentence ID stored in the buffer 2 is executed. As the unprocessed pattern rule to be processed in step S216, not only a pattern rule stored in the step S212, but also a pattern rule stored in steps S218 or S223 (to be described later) may be used.

For example, when a sentence ID stored in the buffer 2 is “120”, if a pattern rule (sentence ID 92) with reference numeral 650 in FIG. 5 or a pattern rule with reference numeral 730 in FIG. 6 is a target to be processed, retrieval in step S216 is executed such that a pattern rule having a sentence ID “120” is used as a range to be retrieved.

When the related pattern rule having the sentence ID stored in the buffer 2 can be retrieved, the retrieved related pattern rule is added to the buffer 1 (S218). In this addition, relationship information such as hierarchical relation information between pattern rules is also stored. When the retrieval result is additionally stored in the buffer 1, a pattern rule which is connected to the retrieved related pattern rule and which is automatically determined as a processed pattern rule is generated in pattern rules stored in the buffer 1 except for the pattern rule serving as the target to be processed. On the other hand, when the related pattern rule having the corresponding sentence ID cannot be retrieved, information representing that the related pattern rule cannot be retrieved and a pattern rule to be processed are stored in the buffer 3 (S219).

It is checked whether the retrieval of the currently retrieved related pattern rule (according to S218) reaches an end category (pattern rule related to S (sentence)) (S220).

When the retrieval does not reach the end category, it is checked whether an unprocessed pattern rule which is not subjected to retrieval of the related pattern rule is left in the buffer 1 or not (S221). If YES in step S200, the control flow returns to step S216.

When the retrieval does not reach the end category, and an unprocessed pattern rule is left in the buffer 1, it is checked whether a pattern rule is stored in the buffer 3 (S222). In this case, when the pattern rule is not stored in the buffer 3, a syntax parsing failure is determined, and the series of processes are ended.

When a pattern rule is stored in the buffer 3, an unprocessed (unprocessed in S223) pattern rule is picked, and a pattern rule (upper pattern rule) related to the picked pattern rule is retrieved from pattern rules except for a pattern rule having a sentence ID stored in the buffer 2, and the retrieved pattern rule is added to the buffer 1 (S223). When the related pattern rule cannot be retrieved in this retrieving process, this result is neglected, and the next process (S224) is started.

These processes are repeated with respect to all the pattern rules stored in the buffer 3 (S224). With respect to all the pattern rules stored in the buffer 3, retrieval from pattern rules which are not related to the sentence ID stored in the buffer 2 is ended. In this case, it is checked whether a pattern rule is added to the buffer 1 in the retrieval in the step S223 (S225).

When a pattern rule is not added to the buffer 1, a syntax parsing failure is determined, and the series of processes are ended. On the other hand, when a pattern rule is added to the buffer 1, the buffer 3 is cleared, and the control flow returns to step S216.

The above bottom-up retrieval is repeated to reach the end category, a syntax parsing success is determined, and the series of processes are ended.

The case in which one sentence ID is stored in the buffer 2 in the process in step S215 is described above. However, a plurality of sentence IDs of a larger number of pattern rules applied to the morpheme (vocabulary) may be stored. In this case, a set of pattern rules each having any one of the plurality of sentence IDs stored in the buffer 2 serves as a retrieval range for a related pattern rule (upper pattern rule). In this case, when the retrieval reaches the end category, a syntax parsing success is determined, a process of canceling a plurality of candidates performed by steps S201 and S202 in FIGS. 19A and 19B according to the third embodiment must be performed.

According to the fourth embodiment, in addition to the same effect as that in the first embodiment, the following effect can be achieved. That is, in construction of a syntax parsing tree, application of pattern rules including any one of all the vocabularies is determined first, and, subsequently, pattern rules having the selected sentence ID are preferentially applied. For this reason, a retrieval space can be narrowed, a high-speed operation can be expected, and a plurality of candidates can be almost prevented from being generated when the syntax parsing tree is formed.

(E) Another Embodiment

Also in the descriptions of the embodiments, various modifications are mentioned. However, in addition, another modification (will be illustrated below) can be explained.

In place of the method of forming a pattern rule with sentence ID described in the first embodiment, the following method can be applied. That is, when a document which is desired to be referred to exists in advance, and when a user wants to form a pattern rule from the document, syntax parsing is performed by using a syntax parsing tool such as a tool described in http://cl.aist-nara.acjp/lab/nlt/NLT.html using a statistical method. The syntax parsing result is divided into pattern rules in units of phrases such as a noun phrase, an adjective phrase, and an adverb phrase to form pattern rules.

As a method of forming a translation pattern rule with sentence ID (see the second embodiment), the following method can be applied. That is, when a translation document which is desired to be referred to exists in advance, and when a user wants to form a translation pattern rule from the document, a method described in the specification and drawings of Japanese Patent Application No. 2002-367553 is used to make it possible to form a translation pattern rule.

A plurality of with-sentence-ID (translation) pattern dictionaries may exist. The plurality of with-sentence-ID (translation) pattern dictionaries are prepared in units of fields or documents, the with-sentence-ID (translation) pattern dictionaries are selectively used depending on a field or a document which is desired to be referred to, so that a syntax parsing result or a translation result obtained by imitating a result in the reference field or the reference document can be obtained.

In the above embodiments, an English syntax parsing apparatus or an English-Japanese mechanical translation apparatus has been exemplified. However, a language to be processed may by any language.

The characteristic technical idea of the third or fourth embodiment can be applied to a mechanical translation apparatus or a syntax parsing process (see the second embodiment).

A parsing result or a translation result in each of the embodiments is displayed for a user, and the result is caused to be checked by the user. If the result is correct, all the used (translation) pattern rules are stored in the with-sentence-ID (translation) pattern rule dictionary, or a sentence ID is given to a pattern rule which has no sentence ID, and the pattern rule is stored in the with-sentence-ID (translation) pattern rule dictionary. When the apparatus is frequently used, a large number of rules are accumulated, and the processing accuracy can also be improved. More specifically, a pattern rule learning section or a user registration section may be arranged. Sentence IDs may be automatically given to all pattern rules constituting a syntax parsing result obtained for a certain document or a pattern rule which does not have a sentence ID without being checked by a user and stored in the with-sentence-ID pattern rule dictionary.

Not only the case in which a pattern rule to which the sentence ID described in the first embodiment is given does not exist, but also cancellation of a plurality of candidates using sentence IDs and cancellation of a plurality of candidates using cost calculation described in Patent Document 2 can be combined to each other. For example, even though the number of sentence IDs the number of which is maximum is a predetermined number or less, a method of canceling a plurality of candidates using sentence IDs is not used, and a method of canceling a plurality of candidates using the cost calculation described in Patent Document 2 is used. For example, a term including a count number of sentence IDs as a parameter is set in an equation of the cost calculation described in Patent Document 2, a cost which is inversely proportional to the number of sentence IDs is defined, and the cost and the cost of a syntax parsing result defined elsewhere are calculated, and a pattern rule obtained at the lowest cost is selected, so that an optimum syntax parsing result may be obtained from a plurality of syntax parsing result candidates.

In the first embodiment and the fourth embodiment, sentence ID the count number of which is smaller than a threshold number may be neglected.

Both the categories of sentence IDs and the categories of syntax elements may be evaluated at once. For example, only sentence IDs of pattern rules having some specific category (independent-language category including NP (noun phrase) or VP (verb phrase) may be counted. More specifically, the sentence IDs may be used in consideration of the category of the syntax elements.

In the above embodiments, as the same sentence ID, a sentence ID given to pattern rules formed on the basis of the same sentence is described. However, a sentence ID may be given as a simultaneous application rate of pattern rules.

For example, a common sentence ID is given to pattern rules which are easily simultaneously applied, so that a parsing result consisting of a combination of patterns which are easily simultaneously applied is preferentially selected. The same sentence ID may be given not only when patterns simultaneously appear in one sentence in a past document but also when another method is used. For example, pattern rules are categorized depending on related fields, and the same sentence IDs are given in units of the related fields. In this case, a parsing result consisting of a combination of pattern rules of the same related field is preferentially applied. The categorization of pattern rules in units of the related fields can be performed as follows. That is, sentences are divided by the fields, and sentence IDs are given to pattern rules obtained from the sentences.

For example, on the basis of “work a 40 hour week”, a pattern rule is formed, and a sentence ID is given to the pattern rule. In this case, a pattern rule is formed in consideration of a similar sentence “work a 5 day week” of the given sentence, and the same sentence ID may also be given to the formed pattern rule.

As described above, according to the present invention, a with-sentence-ID pattern rule to which a sentence ID representing the possibility of simultaneously applying the sentence ID to the same sentence is given is prepared, and a syntax parsing result in which the number of pattern rules to which the same sentence ID is give is large is employed. For this reason, the accuracy of the syntax parsing result can be improved.

What is claimed is:

1. A natural language processing apparatus which uses a pattern rule having at least a pattern name and a pattern constituent element to obtain a syntax parsing result of at least an input sentence, comprising:
a with-sentence-ID pattern rule dictionary in which a pattern rule to which a sentence ID representing the probability of simultaneously applying a pattern rule to the same sentence is given is stored;
a morphological parsing section for morphologically parsing an input sentence to be parsed; and
a syntax parsing section which obtains a syntax parsing result constituted by a tree structure of a plurality of pattern rules with respect to a morphological parsing result with reference to the with-sentence-ID pattern rule dictionary and which employs a tree structure between pattern rules having pattern rules to which the same sentence ID is given and which increase in number.

2. A natural language processing apparatus according to claim 1, wherein, after the syntax parsing section obtains a syntax parsing result constituted by a tree structure of a plurality of pattern rules without consideration the sentence ID, on the basis of the sentence ID given to the pattern rules included in the result, cancellation of a plurality of candidates is performed such that the number of pattern rules to which the same sentence ID is given increases, and a final syntax parsing result is obtained.

3. A natural language processing apparatus according to claim 2, wherein when the syntax parsing section count the pattern rules to which the same sentence ID is given, if a plurality of same pattern rules exist in a disjunctive structure, the pattern rules are counted one pattern rule.

4. A natural language processing apparatus according to claim 1, wherein the syntax parsing section determines lower pattern rules of a tree structure with reference to the with-sentence-IC pattern rule dictionary in each morpheme in the morphological parsing result and performs retrieval of an upper pattern rule for each of the lower pattern rules in preference to pattern rules to which the same sentence ID as that given to the lower pattern rules to obtain a final syntax parsing result.

5. A natural language processing apparatus according to claim 1, wherein the syntax parsing section determines lower pattern rules of a tree structure with reference to the with-sentence-IC pattern rule dictionary in each morpheme in the morphological parsing result, detects a sentence ID which is frequently given to the plurality of predetermined lower pattern rules, and performs retrieval of an upper pattern rule for each of the lower pattern rules in preference to pattern rules to which the same sentence ID as the detected sentence ID to obtain a final syntax parsing result.

6. A natural language processing apparatus according to claim 1, wherein, as a dictionary from which a pattern rule is retrieved, in addition to the with-sentence-IC pattern rule dictionary, a general-purpose pattern rule dictionary in which general-purpose pattern rules having no sentence ID are stored is arranged.

7. A natural language processing apparatus according to claim 1, wherein a pattern rule with sentence ID can be additionally registered in the with-sentence-IC pattern rule dictionary.

8. A natural language processing apparatus according to claim 1, wherein, as the with-sentence-IC pattern rule dictionary, a plurality of with-sentence-IC pattern rule dictionaries which are discriminated depending on documents, fields, and the like.

9. A natural language processing apparatus according to claim 1, wherein the natural language processing apparatus is a mechanical translation apparatus, and the syntax parsing section performs syntax parsing to an original-language sentence.

10. A natural language processing method which uses pattern rules having at least pattern names and pattern constituent elements to obtain a syntax parsing result of at least an input sentence, comprising:
the morphological parsing step of preparing a with-sentence-ID pattern rule dictionary in which a pattern rule to which a sentence ID representing the probability of simultaneously applying a pattern rule to the same sentence is given is stored in advance and morphologically parsing an input sentence to be parsed; and
the syntax parsing step of obtaining a syntax parsing result constituted by a tree structure of a plurality of pattern rules with respect to a morphological parsing result with reference to the with-sentence-ID pattern rule dictionary and employing a tree structure between pattern rules having pattern rules to which the same sentence ID is given and which increase in number.

11. A natural language processing method according to claim 10, wherein, in the syntax parsing step, after a syntax parsing result constituted by a tree structure of a plurality of pattern rules is obtained without consideration the sentence ID, on the basis of the sentence ID given to the pattern rules included in the result, cancellation of a plurality of candidates is performed such that the number of pattern rules to which the same sentence ID is given increases, and a final syntax parsing result is obtained.

12. A natural language processing method according to claim 11, wherein, in the syntax parsing step, when the pattern rules to which the same sentence ID is given are counted, if a plurality of same pattern rules exist in a disjunctive structure, the pattern rules are counted one pattern rule.

13. A natural language processing method according to claim 10, wherein, the syntax parsing step, lower pattern rules of a tree structure are determined with reference to the with-sentence-IC pattern rule dictionary in each morpheme in the morphological parsing result, retrieval of an upper pattern rule for each of the lower pattern rules is performed in preference to pattern rules to which the same sentence ID as that given to the lower pattern rules to obtain a final syntax parsing result.

14. A natural language processing method according to claim 10, wherein, in the syntax parsing step, lower pattern rules of a tree structure are determined with reference to the with-sentence-IC pattern rule dictionary in each morpheme in the morphological parsing result, a sentence ID which is frequently given to the plurality of predetermined lower pattern rules is detected, and retrieval of an upper pattern rule for each of the lower pattern rules is performed in preference to pattern rules to which the same sentence ID as the detected sentence ID to obtain a final syntax parsing result.

15. A natural language processing method according to claim 10, wherein, as a dictionary from which a pattern rule is retrieved, in addition to the with-sentence-IC pattern rule dictionary, a general-purpose pattern rule dictionary in which general-purpose pattern rules having no sentence ID are stored is arranged.

16. A natural language processing method according to claim 10, wherein a pattern rule with sentence ID can be additionally registered in the with-sentence-IC pattern rule dictionary.

17. A natural language processing method according to claim 10, wherein, as the with-sentence-IC pattern rule dictionary, a plurality of with-sentence-IC pattern rule dictionaries which are discriminated depending on documents, fields, and the like.

18. A natural language processing method according to claim 10, wherein the natural language processing apparatus is a mechanical translation apparatus, and the syntax parsing step performs syntax parsing to an original-language sentence.

19. A natural language processing program in which the natural language processing method according to claim 10 is described in a code which can be executed by a computer.
